(19) United States
(12) Patent Application Publication
(10) Pub. No.: US 2007/0039678 A1
(43) Pub. Date: Feb. 22, 2007

(54) Method for production of layered substrates

(75) Inventors: Bo Johnsson, Alno (SE); Morgan Grothage, Bergeforsen (SE); Bjorn Engstrom, Alno (SE)

Correspondence Address: WHITE, REDWAY & BROWN LLP, 1217 KING STREET, ALEXANDRIA, VA, 22314, US

(73) Assignee: Akzo Nobel Coatings International B.V., SB Arnhem (NL)

(21) Appl. No.: 11/505,497

(22) Filed: Aug. 17, 2006

Related U.S. Application Data
(60) Provisional application No. 60/709,127, filed on Aug. 18, 2005.

(51) Int. Cl. B32B 38/00; B32B 37/00; B32B 37/12; B05C 5/02; B32B 41/00; C09J 5/04

(52) U.S. Cl. 156/64; 156/314; 156/315; 156/356; 156/378

(57) ABSTRACT

The present invention relates to a method, a system, computer readable mediums and computer program products for controlling a process for producing a layered substrate. The method comprises the steps of: collecting (32) at least one first set of measurement data related to parameters of a substrate at a first process stage located upstream a pressing step in the translation direction (A) of the conveying means (14); collecting (34) at least one second set of measurement data related to parameters of the substrate at a second process stage located upstream a pressing step in the translation direction (A) of the conveying means (14); and controlling (36) resin dosage by using collected measurement data from the first and second process stage and a calculated calibration model, which model is based on collected measurement data of substrates at the first and/or second process stage.

The present invention generally relates to the production of layered substrates and, in particular, to a method and system for monitoring or controlling resin application in the production of layered substrates including layered wood based products.

### BACKGROUND OF THE INVENTION

Layered substrates such as layered wood based products are normally manufactured by coating a substrate such as a board with a layer. Suitable boards include e.g. particle boards, medium density fibre boards, plywood, waferboards, oriented strand boards (OSB), hardboards. The layer can be applied on the board by means of veneering, flooring or foliating in order to produce, for example, paper laminated particleboard, laminate flooring, parquet flooring, medium density overlaid (MDO) plywood, shuttering board, veneered board and the like. At application of the layer a number of different resin applicators including roll coaters, curtain coaters, extruders, sprayers etc. can be used.

However, a problem encountered in the production of layered wood based products, regardless of the technique or device used for applying the resin, is the determination of the dosage of resin to be applied on a specific board and also the maintaining of the desired resin dosage. The required or proper dosage of resin may vary significantly between different boards, even within the same consignment, due to shifting properties or characteristics between different boards such as wood species in the board, moisture content, particle size in the surface layer, board density, amount of urea/formaldehyde resin in the surface layer, the varying degree of penetration of resin into the substrate, etc. Other factors may be connected to the production line including line speed of conveyor, hardener dosage, thickness of the board, etc. In addition, changes may occur in the resin itself.

Such changing properties or characteristics of the boards and/or production line factors can result in non-uniform resin-application of the boards. Furthermore, they can entail over-dosage of resin, which, in turn, may lead to higher costs (due to the fact that an unnecessary large amount of resin is used), fibre aberrations such as erection of fibres in the surface layer of the substrate causing a rough surface of the board, which, in turn, may give rise to the so called “orange peel” effect. Moreover, over-dosage may result in, inter alia, discolouration of the applied surface and blisters in the substrate-layer interface. Under-dosage of resin is also a serious problem, which, for example, may lead to that the applied layer disengages from the board. Hence, it is essential that the resin dosage is accurately adjusted with respect to these varying properties of the specific board, changed characteristics of the production line and/or the resin itself etc.

Another parameter of importance in production of layered substrates is the penetration of resin into the substrates, which is closely related to the presence of pores in the substrate. The phenomenon of penetration of resin is essential for the quality of the layered product. This is owing to the fact that the amount of applied resin penetrating into the substrates does not take part in the glue joint in the gluing process of the product, which of course depends on the penetration depth. Penetration into a substrate like a particleboard might be related to parameters such as moisture content, hydrophobic properties of the substrate surface, presence of pores on a macroscopic scale due to distance between sawdust particles forming the board surface but also on a microscopic scale due to presence of resin channels, bordered pits and lumens of the tracheids in the wood material. The presence of pores in a particleboard is closely related to the permeability of the particleboard. Permeability is measured by simply measuring the transport of air through the board. Other analytical tools which might have potential of measuring responses related to penetration is contact angle analysis in static and dynamic mode.

WO 2004/094947, Mbachu et al. discloses a method for spectroscopically monitoring resin-application of veneer-wood sheets during travel in an assembly line. Spectroscopic instrumentation for monitoring applied resin is calibrated by measurements of predetermined resin applications to reference-test-samples so as to provide a predetermined relationship enabling monitoring of applied resin during commercial production of a veneer-wood product using the visible light spectrum and near infrared extending to 2500 nm. The. spectroscopic measurement is performed directly after the resin applicator by means of a probe adapted to enable a selection of wavelengths of electromagnetic radiation within the above-mentioned range. However, the method according to WO 2004/094947, Mbachu et al. does not take into account effects such as, for example, the degree of penetration of resin into the substrate.

Furthermore, moisture content of the substrate might vary between different substrates. Since the resin used, for example, urea/formaldehyde (UF) or phenol/formaldehyde (PF) also contains water, there is an considerable risk of interference from the water (in the resin and in the substrate) in the NIR spectra when the resin application is measured using the methods disclosed in WO 2004/094947, Mbachu et al.

Moreover, the substrates may also contain amounts of UF resin load in the surface layer, which, in addition, may vary between different substrates. This can induce errors in the NIR spectra when the resin application is measured using the methods disclosed in WO 2004/094947, Mbachu et al.

Thus, there is a need of an improved method and system for monitoring or controlling or monitoring parameters, e.g. resin dosage or permeability of the substrates, in the production of layered substrates, such as layered wood based products.

### BRIEF DESCRIPTION OF THE INVENTION

An object of the present invention is to provide an improved method and system for monitoring or controlling parameters, e.g. resin dosage or permeability of the substrates, in the production of layered substrates, such as layered wood based products.

Another object of the present invention is to provide an improved method and system for monitoring or controlling resin application in the production of layered substrates, such as layered wood based products, with respect to accuracy of resin dosage.

These and other object are obtained by the present invention by providing a method, a system, a computer readable medium, and a computer program having the features defined in the independent claims. Different embodiments are defined in the dependent claims.

In the context of this application, the term “substrate” refers to a panel such as a board including, inter alia, particle boards, medium density fibre boards, plywood boards, waferboards, oriented strand boards (OSB), and handboards.

In connection with this application, the term “layered substrate” refers to a substrate provided with a layer by means of, inter alia, veneering, flooring, or foliating.

According to a first aspect of the present invention, there is provided a method for controlling a process for producing a layered substrate, the process involving the steps of applying a hardener on the substrate; applying a resin on the substrate; and conveying the substrate to a press by means of a conveying means where at least one layer is applied on the substrate in a pressing step in order to form a layered substrate. The method further comprises the steps of: collecting at least one first set of measurement data related to parameters of the substrate at a first process stage employing a first measurement means, the first process stage being localized upstream the pressing step in the translation direction of the conveying means; collecting at least one second set of measurement data related to parameters of the substrate at a second process stage employing a second measurement means, the second process stage being localized upstream the pressing step and downstream the first process stage in the translation direction of the conveying means; and controlling an amount of resin to be applied on a substrate in the step of applying resin during the process for producing layered substrates by using collected measurement data from the first and second process stage and a calculated calibration model, the model being based on collected measurement data of substrates at the first and/or second process stage.

According to a second aspect of the present invention, there is provided a system for controlling a process for producing a layered substrate, such as a layered wood based substrate, the system comprising means for applying a hardener on the substrate; means for applying a resin on the substrate; and conveying means adapted to translate the substrate to pressing means adapted to apply at least one layer on the substrate in order to form a layered substrate. The system further comprises a first measurement means adapted to collect at least one first set of measurement data related to parameters of the substrate at a first process stage, the first measurement means being arranged upstream the pressing means in the translation direction of the conveying means; a second measurement means adapted to collect at least one second set of measurement data related to parameters of the substrate at a second process stage, the second measurement means being arranged upstream the pressing means and downstream the first measurement means in the translation direction of the conveying means; and control means connected to the first and second measurement means being adapted to control the resin applying means in order to determine an amount of resin to be applied on a substrate during the process for producing a layered substrate by using collected measurement data from the first and second process stage and a calculated calibration model, the model being based on collected measurement data of substrates at the first and/or second process stage.

According to third aspect of the present invention, there is provided a computer program for a system according to the second aspect of the present invention. The program comprises program instructions, which when run in a control means of the system, causes the control means to perform steps of the inventive method.

According to fourth aspect of the present invention, there is provided a computer program product comprising computer readable medium and a computer program according to the third aspect, wherein the computer program is stored on the computer readable medium.

Thus, the present invention is based on the insight that the effect of penetration of resin into the substrate is essential when determining the resin application (the resin dosage) due to the fact that the amount of resin penetrating into the substrate is not taking part in the glue joint in the gluing process of the product (depending on the penetration depth). The penetration of resin into a substrate, such as a particleboard, might be related to parameters such as moisture content, hydrophobic properties of the substrate surface, etc. Moreover, the invention is also based on the insight that these properties can be quantified by spectroscopy using measurement probes located at, at least two specific process stages along a production line for producing layered substrates. Thereby, it is possible to develop a calibration model, based on data collected at these at least two process stages, capable of providing a high predictive ability with regards to, for example, resin dosage. The present invention provides several advantages in comparison with the conventional technique disclosed in WO 2004/094947, Mbachu et al., in which effects such as, for example, the degree of penetration of resin into the substrate are not take into account. For example, the present invention provides for a highly accurate and reliable control of the resin application since effects such as the penetration depth is taken into account in the calibration model.

According to an embodiment of the present invention, the first process stage, i.e. the first measurement means, is located upstream the hardener applier stage. It has been found in tests that this location of the first measurement means provides especially useful measurement data for the calibration model as well as for the control of the resin dosage during the production process.

In an embodiment of the present invention, the second process stage is located downstream resin applier stage. It has been found in tests that this location of the second measurement means provides especially useful measurement data for the calibration model as well as for the control of the resin dosage during the production process.

In yet another embodiment of the present invention, data related to the hardener dosage applied on the substrate is collected during production of the layered substrate, and the hardener dosage data is used in the control of the resin dosage. Thereby, the accuracy and reliability of the calibration model as well as the control of the resin dosage during the production process can be improved even further.

In a further embodiment, data related to related to the line speed of the conveyer during production of a layered substrate is collected and used in the control of the resin dosage. Thereby, the accuracy and reliability of the calibration model as well as the control of the resin dosage during the production process can be enhanced.

According to other embodiments of the present invention, data related to process variables such as temperature and/or atmospheric humidity of the process premises, the temperature of the press, or the effect of the heater can be collected and used in the control of the resin dosage.

Preferably, the calibration model is calculated by means of multivariate analysis. According to embodiments, PLS, PCA, or PCR, are multivariate techniques that can be used in the invention. Furthermore, neural networks are also a technique that can be used for developing the calibration model.

According to an embodiment of the present invention, the calibration model is calculated in accordance with the following steps: the collected measurement data at the first process stage is arranged in at least one matrix; a first sub-model for the first process stage is calculated using multivariate analysis; and receiving, in the second process stage from at least a first process stage, information related to a multivariate sub-model calculated for at least the first process stage. Thereby, a model having a higher degree of predictability can be obtained, i.e. the resin dosage predicted by means of the model shows a higher degree of accuracy and reliability. This is due to the fact that variations in the substrate, for example, moisture content variation or differences in UF resin load in the surface layer of the substrate is included in the first sub-model and transferred into the second sub-model as principal component of a multivariate analysis model (such as a PCA or PLS model). The use of principal components instead of a full spectrum reduces the risk of over fit and related problems due to many uncorrelated variables and noise in the calibration model.

The measurement data may be collected by means of spectroscopic measurements made in the ultra-violet (UV), infrared (IR), near-infrared (NIR), or visible light (Vl) spectra, and preferably in the near-infrared (NIR) spectrum. In an alternative embodiment, the measurement data may be collected by means of ultra sound.

According to an embodiment of the present invention, the calibration model is used to control the permeability of the substrate.

The features that characterize the invention, both as to organization and to method of operation, together with further objects and advantages thereof, will be better understood from the following description used in conjunction with the accompanying drawings. It is to be expressly understood that the drawings is for the purpose of illustration and description and is not intended as a definition of the limits of the invention. These and other objects attained, and advantages offered, by the present invention will become more fully apparent as the description that now follows is read in conjunction with the accompanying drawings.

### DETAILED DESCRIPTION OF THE DRAWINGS

In the following detailed description of the invention reference will be made to the accompanying drawings, of which

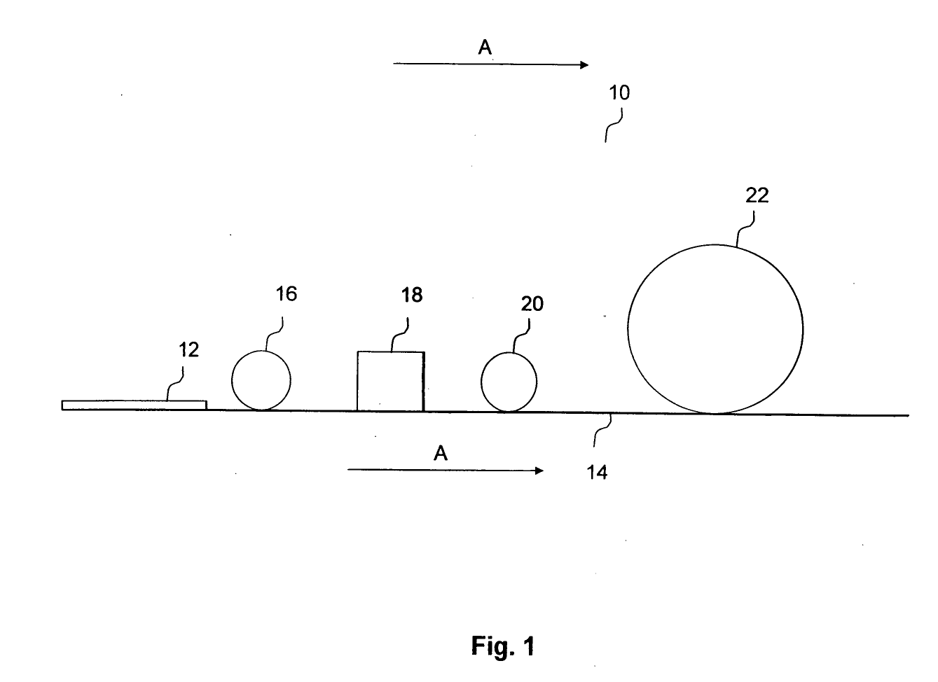

FIG. 1 is a schematic view of a production line for producing a layered substrate at which the present invention can be utilized.

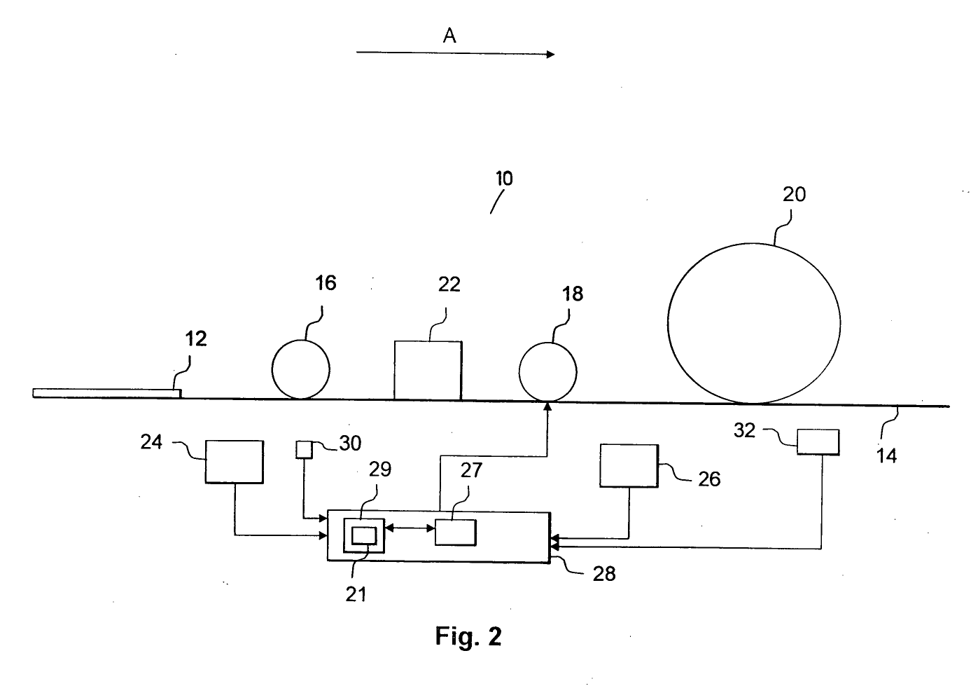

FIG. 2 is a schematic view of a system for monitoring resin-application during production of a layered substrate at the production line shown in FIG. 1 according to an embodiment of the present invention.

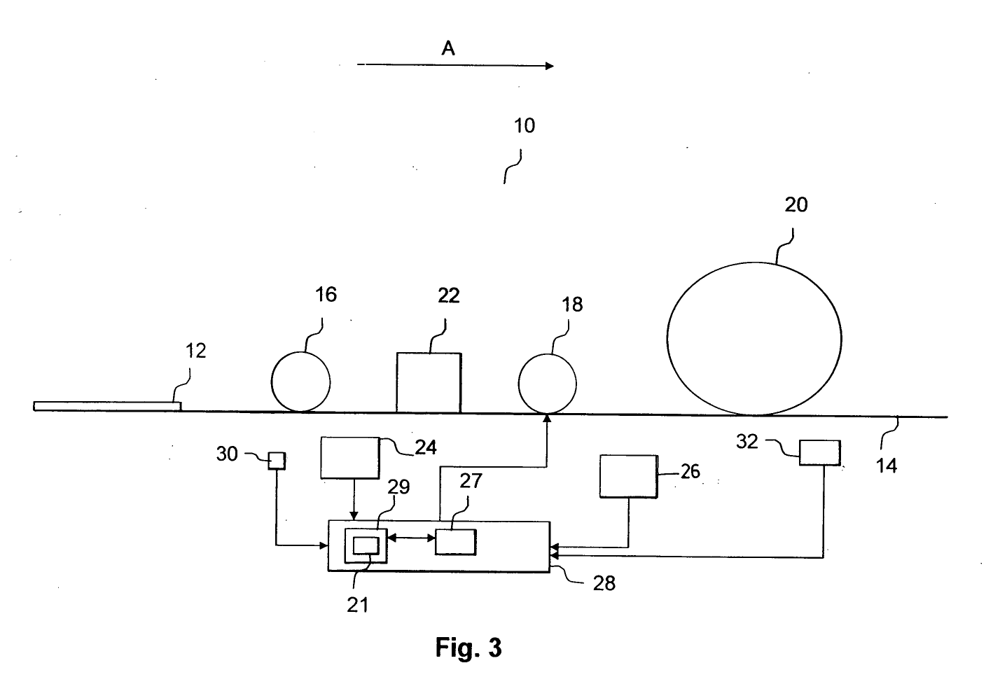

FIG. 3 is a schematic view of a system for monitoring resin-application during production of a layered substrate at the production line shown in FIG. 1 according to another embodiment of the present invention.

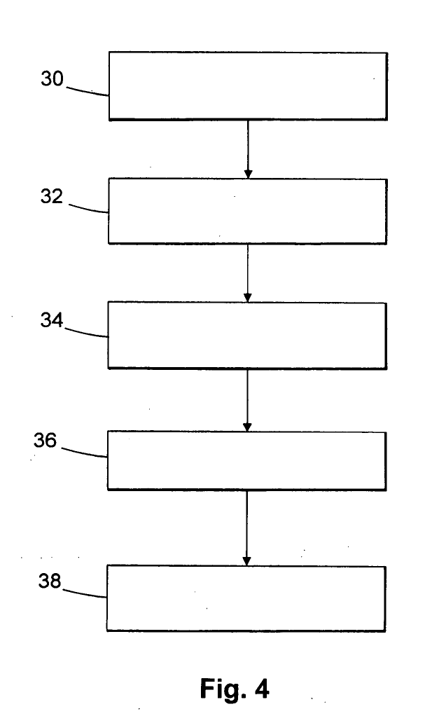

FIG. 4 shows the general principles of the method for monitoring resin-application during production of a layered substrate at the production line shown in FIG. 2 or FIG. 3 according to an embodiment of the present invention.

### DESCRIPTION OF PREFERRED EMBODIMENTS

With reference first to FIG. 1, a production line for producing a layered substrate at which the system and method according to the present invention can be utilized will be described.

The production line 10 comprises means for applying a hardener 16 adapted to apply a hardener on the substrate 12, for example, a spreader, means for applying a resin 18 on the substrate, for example, a resin spreader, and a pressing means 20, such as a hot roll press, adapted to apply at least one layer on the substrate in order to form a layered substrate. However, as the skilled man realizes, the layer may be applied on the substrate by means of, for example, flooring, veneering or foliation. The layer may be, for example, paper, veneer, or textile. Moreover, it should also be noted that there are a number of other suitable pressing means in addition to a hot roll press that are conceivable including a plane pressing machine, which however is not suitable in the case of foliation, or a cold pressing machine.

Substrates, such as wood based products in form of boards, 12 are transported or conveyed by means of a conveyer means 14 between the different process stages of the production line 10 in a direction of the arrow indicated with an A. Between the hardener spreader 16 and the resin spreader 18 is a heater 22 arranged, which heater is adapted to heat the substrate in order to dry the applied hardener. Preferably, the heater 22 is an IR-heater. Usually, a saw (not shown) is arranged downstream of the hot roll press 20 in order to saw the substrate in pieces having a desired dimension.

Turning now to FIG. 2, a system for monitoring resin-application during production of a layered substrate installed at the production line shown in FIG. 1 according to an embodiment of the present invention will be described. A first measurement means 24 adapted to collect at least one first set of measurement data related to parameters of the substrate is arranged at a first process stage, which in this embodiment is located upstream the hot roll press 20. Preferably, the first measurement means is located upstream hardener spreader 16. Furthermore, a second measurement means 26 adapted to collect at least one second set of measurement data related to parameters of the substrate is arranged at a second process stage. In this embodiment, the second measurement means 26 is located upstream the hot roll press 20 and downstream the first measurement means 24. Preferably, the second measurement means 26 is located between the resin spreader 18 and the hot roll press 20.

According to preferred embodiment, the first and second measurement means 24 and 26 are spectroscopic probes adapted emit wavelengths of electromagnetic radiation in one or more ranges of peak absorbance by the applied resin, and by other constituents, such as moisture content of the substrate material and of the resin. In particular, the electromagnetic radiation is in form of ultra-violet, infrared, near-infrared, or visible light. If near infrared light is used, so called NIR probes may be utilized.

Furthermore, the system comprises control means 28 comprising processing means 27 connected to the first and second measurement means 24 and 26, respectively. The control means 28 controls whether the first and second measurement means 24 and 26, respectively, should be active or not, i.e. when measurements should be performed. Furthermore, the control means 28 comprises a storage means 29 communicating with the processing means 27 via a standard control/address bus (not shown). The storage means 29 may include a random access memory (RAM) and/or a non-volatile memory such as read-only memory (ROM). As will be appreciated by one of ordinary skill in the art, storage means may include various types of physical devices for temporary and/or persistent storage of data which includes solid state, magnetic, optical and combination devices. For example, the storage means may be implemented using one or more physical devices such as DRAM, PROMS, EPROMS, EEPROMS, flash memory, and the like. The storage means 29 may further comprise a computer program 21 comprising instructions for bringing a computer to perform method steps in accordance with the present invention.

The control means 28 is also adapted to control the resin spreader 18 in order to determine an amount of resin to be applied on a substrate during the process for producing a layered substrate. This control of the resin spreader 18 is performed by using collected measurement data, which may be stored in the storage means 29, from the first and/or second measurement means 24 and 26, respectively, and a calculated calibration model, which may be stored in the storage means 29. Preferably, the calibration model is based on collected measurement data of substrates at the first and/or the second process stage.

According to an alternative embodiment of the present invention, measurement data regarding the applied hardener dosage and the line speed of the conveyer 14 can be used when calculating the calibration model. This measurement data can be obtained by means of a hardener dosage measurement device 30 and a line speed sensor 32. The use of integration of process signals in the invention is however not limited to hardener dosage and line speed as the skilled man within the art realizes and other relevant signals from the process can be used for this purpose. Such signals include temperature and/or atmospheric humidity of the process premises, the temperature of the press, or the effect of the heater.

With reference to FIG. 3, an alternative embodiment of the present invention is shown. Parts or devices shown in FIGS. 2 and 3 having similar or like function or functions will be denoted with the same reference numerals. In this embodiment, the first measurement means 24 adapted to collect at least one first set of measurement data related to parameters of the substrate is arranged located downstream hardener spreader 16. Furthermore, the second measurement means 26 adapted to collect at least one second set of measurement data related to parameters of the substrate is located between the resin spreader 18 and the hot roll press 20. The function of and location of other devices and parts, such as the control means 28, are the same as in the embodiment shown in FIG. 2, and, therefore, description thereof are omitted in connection to this embodiment.

Turning now to FIG. 4, the general principles of the method for controlling a process for producing a layered substrate according to the present invention will be described. The different steps will now be described in the flow order for the production process (i.e. in the transport direction of the conveyer 14, which is indicated with the arrow A). First, at step 30, a hardener is applied on the substrate by the hardener spreader 16. Then, at step 32, at least one first set of measurement data related to parameters of the substrate is collected at a first process stage employing a first measurement means 24, which, as indicated above, preferably is a NIR probe adapted to operate with wavelengths within 400-2500 nm. The measurement data is transferred to the control means 28 for use in determining the resin dosage on basis of the calibration model. In one embodiment, the first NIR probe 24 is located upstream the hardener spreader 16. Thereafter, at step 34, at least one second set of measurement data related to parameters of the substrate employing a second measurement means 26, which, as indicated above, preferably is a NIR probe adapted to operate with wavelengths within 400-2500 nm. The measurement data is transferred to the control means 28 for use in determining the resin dosage on basis of the calibration model. In one embodiment, the second NIR probe 26 is located upstream the hot roll press 22 and downstream the resin spreader 19. Subsequently, at step 36, an amount of resin to be applied on the substrate is controlled by using the collected measurement data from the first and second NIR probe 24 and 26, respectively, and a calculated calibration model. The calibration model is, as indicated above and as will be described in greater detail below, based on collected measurement data of substrates by the first and second NIR probe 24 and 26, respectively.

Preferably, the collected measurement data from a substrate at the first process stage, i.e. by the first NIR probe 24, and at the second process stage, i.e. by the second NIR probe 26, during the production process is compared in the control means 28 with reference data of from the calculated calibration model during the production of a layered substrate in order to adjust the resin dosage to the properties of the specific substrate in process.

Finally, at step 38, the substrate is translated to the hot roll press 22, where at least one layer is applied on the substrate in order to form a layered substrate.

As indicated above, data related to hardener dosage applied on substrate test-samples and data related to a line speed of the conveyer means 14 is used when calculating the calibration model.

### Development of the Calibration Model

The NIR spectroscopy technique has gained widespread acceptance in recent years as a powerful diagnostic tool, particularly for assurance and on-line process control purposes in harsh industrial environments (Antti et al. Journal of Chemometrics, 10, 591-603 (1996), Pope J. M. “Near-infrared Spectroscopy of Wood Products” (1995), Conners T. E. and Banerjee S Ed., “Surface Analysis of Paper”, 142-151). Normally, in NIR spectroscopy, wavelengths between 400-2500 nm are used. The fundamental principles of NIR spectroscopy have been summarized in a large number of articles, for example, in Barton Spectroscopy Europe 14, no. 1, 12-18 (2002). One major reason for the success of NIR spectroscopy is the development of multivariate analysis techniques, which have made it possible to handle the huge amount of data created in such NIR measurements, for example, principal component analysis (PCA) and partial least square projection to latent structures (PLS), see inter alia, P. Geladi “Partial least-Squares Regression: A tutorial”, Anal. Chim. Acta, 185, 1-32 (1986). Another technique may be principal components regression (PCR). In recent years, other techniques suitable in for handling large amounts of data has been developed, such as neural networks.

Principal Component Analysis (PCA)

By PCA, a set of correlated variables are compressed into a smaller set of uncorrelated variables. This transformation consists of a rotation of the coordinate system, resulting in the alignment of information of a fewer number of axes than in the original arrangement. Thereby, the variables that are highly correlated with one another will be treated as a single entity. By using PCA, it thus will be possible to obtain a small set of uncorrelated variables still representing most of the information which was present in the original set of variables, but being far easier to use in models. In general, 2 to 15 principal components will account for 85% to 98% of the variance of the variables.

Partial Least Squares Projection to Latent Structures (PLS)

PLS is a modelling and computational method by which quantitative relations can be established between blocks of variables, e.g. a block of descriptor data (spectra) for a series of samples and a block a response data measured on these samples. By the quantitative relation between the blocks, it is possible to enter spectral data for a new sample to the descriptor block and make predictions of the expected response. One great advantage of the method is that the results can be evaluated graphically by different plots. In most cases, visual interpretations of the plot are sufficient to obtain a good understanding of different relations between the variables. The method is based on projections, similar to PCA. The PLS method is disclosed in detail in Carlsson R, “Design and optimization in organic synthesis”, and B. G. M. Vandeginste, O. M. Kvalheim, Eds., “Data handling in science and Technology”, (Elsevier, 1992), vol. 8.

Principal Components Regression (PCR)

PCR is closely related to PCA and PLS. As in PCA, each object in the descriptor block is projected onto a lower dimensional space yielding in scores and ladings. The scores are then regressed against the response block in a least squares procedure leading to a regression model which can be used to predict unknown samples. The same model statistics as in PCA and PLS can be used to validate the model.

PCA, PLS, and PCR are described thoroughly in P. Geladi “Partial least-Squares Regression: A tutorial”, Anal. Chim. Acta, 185, 1-32 (1986).

Hierarchical and Sequential Modelling

Hierachical modelling is a method were scores and/or residuals from one model is used as variables in another model. The method is described by S Wold et al. in “Hierarchical multiblocks PLS and PC models for easier model interpretation and as an alternative to variable selection”, Journal of Chemometrics, vol. 10, 463-482 (1996).

These methods are further developed by S. Wold, WO 2004/003671 A1, describing a method for application in an industrial process, comprising a first sub-process and a second sub-process arranged in a process chain, comprising, for the second sub-process the steps of collecting data and calculating a multivariate sub-model based on collected data, said method being characterized by the steps of receiving in the first sub-process from the second sub-process information related to the multivariate sub-model calculated for the second sub-process, collecting data related to the first sub-process, and calculating a multivariate sub-model for the first sub-process based on collected data and received information.

Neural Networks

Artificial Neural Networks (ANNs) are mathematical descriptions of what is known about a physical structure and mechanism of biological learning and knowledge (J. Zupan, J. Gasteiger, Anl. Chim. Acta. 248 (1991) 1-30.). The ANN can be used for forecasting and prediction of output values and for detection of trends.

### Example: Prediction of Resin Dosage

According to a first example, a first NIR instrument or probe 24 was placed upstream the hardener spreader 16 and a second NIR instrument or probe 26 was placed upstream the hot calendar roller 20 and downstream the resin spreader 20, as schematically shown in FIG. 2. In this example, both instruments were of diode array type operating at 900-1700 nm. Of course, instruments operating at, for example, 400-2500 nm can also be used. However, comparative tests between instruments operating at wavelengths between 900-1700 nm and instruments operating at wavelength between 400-2500 nm have shown similar results. The operation of the instruments 24, 26 were synchronized in order to make it possible to collect spectra from the same test sample board at the two measurements points or process stages. The following variables: board type (two different manufactures), hardener dosage (5-15 g/m²), line speed (12-19 m/min) and resin application (urea/formaldehyde resin UF 1205 from Casco Adhesives AB, 45-70 g/m²) were varied according to an experimental 2⁴ design with three centre points. Measurements of actual resin dosage were made by gravimetric analysis of the test boards before and after the resin application. In this case PLS models for prediction of the resin dosage were used. The PLS models were made using different modelling strategies according to table 1. The training set consisted of four measurements of each setting according to the experimental design. Root mean square error of prediction (RMSEP) for the test set were used to evaluate model performance. R2 represents the cumulative sum of squares of the predicted resin dosage explained by the extracted components. Q2 represents the fraction of the total variation of the resin dosage, which can be predicted by the extracted components, as estimated by cross-validation. In cross-validation parts of the data are kept out of the model development and is then predicted by the model and compared with the actual values.

TABLE 1

| | PLS | | | |
|---|---|---|---|---|
| Model X-block | components | R2 | Q2 | RMSEP |
| A | 6 | 0.84669 | 0.82552 | 3.24 |
| B | 8 | 0.88090 | 0.842141 | 3.53 |
| C | 8 | 0.87076 | 0.816739 | 2.73 |
| D | 8 | 0.85321 | 0.827376 | 2.78 |
| E | 11 | 0.87899 | 0.812446 | 2.32 |

The modelling strategies were as follows:
A) Only the NIR probe downstream the resin spreader. The measurement data contains absorbance values from 128 wavelengths between 900 and 1700 nm from 44 test boards.
B) Both NIR probes were used. The measurement data contains absorbance values from 128 wavelengths between 900 and 1700 nm from 44 test boards.
C) Both NIR probes were used. The measurement data contains absorbance values from 128 wavelengths between 900 and 1700 nm from 44 test boards. The results in table 1 contain the spectral data from the NIR probe downstream the resin spreader and score values for each board from a two principal components PCA analysis of the spectral data from the NIR probe placed upstream the hardener spreader.
D) As in model A including actual line speed and hardener dosage for each board.
E) As in model C including actual line speed and hardener dosage for each board.

The above results clearly demonstrate the advantage of introducing the spectroscopic information from the first NIR probe as scores from a PCA analysis. However, as an alternative, PLS analysis could be used instead of the PCA analysis of the spectral data from the first NIR probe.

Model C is superior to model A and B by comparison of RMSEP and model E is superior to model D. Model E shows the best overall predictive ability of the compared models.

Example: Prediction of Permeability

Particleboards with different characteristics were made according to an experimental design, where board density, relative amount of surface chips and molar ratio between formaldehyde and urea in the Urea/formaldehyde based resin were varied according to a 2³ design. The boards were analyzed using NIR spectroscopy in the wavelength range of 410-2250 nm on rotating boards and the permeability of air through the boards were determined. Modelling of the spectroscopic data using PLS with permeability as the response gave an eight-component model describing 75.1% of the variation in permeability. Thus, the above results indicate that an improved control of the permeability of the substrates can be obtained by using a calibration model in accordance with the present invention.

Although specific embodiments have been shown and described herein for purposes of illustration and exemplification, it is understood by those of ordinary skill in the art that the specific embodiments shown and described may be substituted for a wide variety of alternative and/or equivalent implementations without departing from the scope of the present invention. Those of ordinary skill in the art will readily appreciate that the present invention could be implemented in a wide variety of embodiments, comprising hardware and software implementations, or combinations thereof. This application is intended to cover any adaptations or variations of the embodiments discussed herein. Consequently, the present invention is defined by the wordings of the appended claims and equivalents thereof.

1. A method for controlling a process for producing a layered substrate, said process involving the steps of applying a hardener on said substrate; applying a resin on said substrate; and conveying said substrate to a press by means of a conveying means where at least one layer is applied on said substrate in a pressing step in order to form a layered substrate, said method further comprising the steps of:
collecting at least one first set of measurement data related to parameters of said substrate at a first process stage employing a first measurement means, said first process stage being localized upstream said pressing step in the translation direction of said conveying means;
collecting at least one second set of measurement data related to parameters of said substrate at a second process stage employing a second measurement means, said second process stage being localized upstream said pressing step and downstream said first process stage in the translation direction of said conveying means; and
controlling an amount of resin to be applied on a substrate in said step of applying resin during said process for producing layered substrates by using collected measurement data from said first and second process stage and a calculated calibration model, said model being based on collected measurement data of substrates at said first and/or second process stage.

2. The method according to claim 1, wherein the step of controlling comprises the step of:
comparing said collected measurement data from the substrate at said first and second process stage with reference data of said calculated calibration model during production of the layered substrate.

3. The method according to claim 1, wherein said first process stage is located upstream said step of applying hardener on said substrate.

4. The method according to claim 1, wherein said second process stage is located downstream said step of applying resin on said substrate.

5. The method according to claim 1, further comprising the steps of:
obtaining data related to hardener dosage applied on a substrate during production of the layered substrate; and
using said hardener dosage data in said step of controlling.

6. The method according to claim 1, further comprising the steps of:
obtaining data related to a line speed of said conveyer during production of the layered substrate; and
using said line speed data in said step of controlling.

7. The method according to claim 1, wherein said calibration model is calculated by means of multivariate analysis.

8. The method according to claim 1, further comprising the steps of:
collecting measurement data of substrate test samples at said first process stage;
arranging the collected measurement data of said test samples at said first process stage in at least one matrix;
calculating a first sub-model for said first process stage using multivariate analysis; and
receiving, in the second process stage from at least a first process stage, information related to a multivariate sub-model calculated for at least said first process stage.

9. The method according to claim 1, wherein said measurement data is collected by means of a spectrometric method and/or from process variables.

10. The method according to claim 9, wherein said spectrometric method uses ultra-violet, infrared, near-infrared, or visible light.

11. A system for controlling a process for producing a layered substrate, said system comprising means for applying a hardener on said substrate; means for applying a resin on said substrate; and conveying means adapted to translate said substrate to a pressing means adapted to apply at least one layer on said substrate in order to form a layered substrate, said system further comprising:
a first measurement means adapted to collect at least one first set of measurement data related to parameters of said substrate at a first process stage, said first measurement means being arranged upstream said pressing means in the translation direction of said conveying means;
a second measurement means adapted to collect at least one second set of measurement data related to parameters of said substrate at a second process stage, said second measurement means being arranged upstream said pressing means and downstream said first measurement means in the translation direction of said conveying means; and
control means connected to said first and second measurement means being adapted to control said resin applying means in order to determine an amount of resin to be applied on a substrate during said process for producing a layered substrate by using collected measurement data from said first and second process stage and a calculated calibration model, said model being based on collected measurement data of substrates at said first and/or second process stage.

12. The system according to claim 11, wherein said control means is adapted to compare said collected measurement data from the substrate at said first and second process stages with reference data of said calculated calibration model during production of a layered substrate.

13. The system according to claim 11, wherein said first measurement means is located upstream said hardener applying means.

14. The system according to claim 11, wherein said second measurement means is located downstream said resin applying means.

15. The system according to claim 11, wherein said first measurement means is a probe adapted to collect data by means of a spectrometric method.

16. The system according to claim 11, wherein said second measurement means is a probe adapted to collect data by means of a spectrometric method.

17. A system for controlling a process for producing a layered substrate at a process line, said process line comprising means for applying a hardener on said substrate; means for applying a resin on said substrate; and conveying means adapted to translate said substrate to pressing means adapted to apply at least one layer on said substrate in order to form a layered substrate, said system further comprising:
a first measurement means adapted to collect at least one first set of measurement data related to parameters of said substrate at a first process stage, said first measurement means being arranged upstream said pressing means in the translation direction of said conveying means;
a second measurement means adapted to collect at least one second set of measurement data related to parameters of said substrate at a second process stage, said second measurement means being arranged upstream said pressing means and downstream said first measurement means in the translation direction of said conveying means; and
control means connected to said first and second measurement means being adapted to control said resin applying means in order to determine an amount of resin to be applied on a substrate during said process for producing a layered substrate by using collected measurement data from said first and second process stage and a calculated calibration model, said model being based on collected measurement data of substrates at said first and/or second process stage.

18. The system according to claim 17, wherein said system is arranged in accordance with claim 11.

19. A computer program product, which when executed on a computer, performs steps in accordance with claim 1.

20. Computer readable medium comprising instructions for bringing a computer to perform a method according to claim 1.
